(19) United States
(12) Patent Application Publication
(10) Pub. No.: US 2024/0420200 A1
(43) Pub. Date: Dec. 19, 2024

(54) Expanding Cartographic Information Sharing with Digital Maps Depicting Geographic Information Referenced in Media

(71) Applicant: Jeffrey Hill Manternach, Lake Oswego, OR (US)

(72) Inventor: Jeffrey Hill Manternach, Lake Oswego, OR (US)

(21) Appl. No.: 18/335,918

(22) Filed: Jun. 15, 2023

(51) Int. Cl. G06Q 30/0601; G01C 21/00; G06Q 30/0202; G06T 11/00

(52) U.S. Cl. CPC G06Q 30/0621; G01C 21/3833; G06Q 30/0202; G06Q 30/0625; G06T 11/00; G06Q 20/1235; G06Q 20/29; G06T 2200/24

(57) ABSTRACT

Systems and methods are disclosed for handling digital maps depicting geographic information referenced in media. The present disclosure facilitates translation of geographic information in underlying media into cartographic information in the form of digital maps, providing a new way for users to interact with existing media and providing a single repository for geographic information in underlying media.

### BACKGROUND

Literature, songs, films and other forms of media often contain geographic locations and character movements among locations. Occasionally, maps accompany such media, for example a printed fiction book that contains an overview map depicting the general geographic area where part of the story takes place. However, many pieces of original media lack maps entirely, or if maps are provided, such maps may generally be insufficient for consumers of such media to gain an adequate geographic understanding of locations and movements referenced in such media. Additionally, there is no single repository for maps related to media. Those wishing to locate maps related to media have to search a multitude of sources, each of which may be unique to the underlying piece of media. The present disclosure targets these existing shortcomings.

### BRIEF DESCRIPTION OF THE DRAWINGS

FIG. 1 is a diagram of one embodiment of a computer system, in accordance with an exemplary embodiment;

FIG. 2 is a diagram of one embodiment of a network environment suitable for creating, selling, finding, purchasing, or displaying digital maps depicting geographic information referenced in media;

FIG. 3 is a diagram of one embodiment of a method for creating digital maps depicting geographic information referenced in media, in accordance with an exemplary embodiment;

FIG. 4 is a diagram of one embodiment of a method for selling digital maps depicting geographic information referenced in media, in accordance with an exemplary embodiment;

FIG. 5 is a diagram of one embodiment of a method for finding digital maps depicting geographic information referenced in media, in accordance with an exemplary embodiment;

FIG. 6 is a diagram of one embodiment of a method for purchasing digital maps depicting geographic information referenced in media, in accordance with an exemplary embodiment;

FIG. 7 is a diagram of one embodiment of a method for displaying digital maps depicting geographic information referenced in media, in accordance with an exemplary embodiment;

FIG. 8 is an example digital map depicting locations and a character movement in The Adventures of Sherlock Holmes by Sir Arthur Conan Doyle.

### DETAILED DESCRIPTION

Systems and methods are disclosed for creating, selling, finding, purchasing, or displaying digital maps depicting geographic information referenced in media. Creating, selling, finding, purchasing, displaying, or any combination thereof are “handling”.

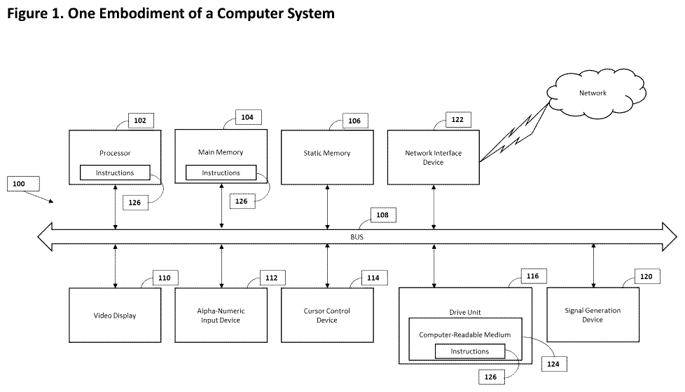

FIG. 1. is a diagram of one embodiment of a machine in the exemplary form of a computer system 100 within which a set of instructions, for causing the machine to perform any one of the methodologies discussed herein, may be executed. In alternative embodiments, the machine may comprise a network router, a network switch, a network bridge, mobile device, eBook reader, a cellular telephone, a smartphone, a tablet, a laptop computer, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a video display unit 110 (e.g., a liquid crystal display (LCD) or a light emitting diode display (LED)). The computer system 100 also includes an alpha-numeric input device 112 (e.g. a keyboard), a cursor control device 114 (e.g. a mouse), a disk drive unit 116, a signal generation device 120 (e.g., a speaker) and a network interface device 122.

The disk drive unit 116 includes a computer-readable medium 124 on which is stored a set of instructions (i.e., software) 126 embodying any one, or all, of the methodologies described herein. The software 126 is also shown to reside, completely or at least partially, within the main memory 104 and/or within the processor 102. The software 126 may further be transmitted or received via the network interface device 122 which may be connected via ethernet cable or other physical connection or communicate wirelessly. For the purposes of this specification, the term “computer-readable medium” shall be taken to include any medium that is capable of storing or encoding a sequence of instructions for execution by the machine and that cause the machine to perform any one of the methodologies of the present invention. The term “computer-readable medium” shall accordingly be taken to include, but not be limited to, solid-state memories, and optical and magnetic disks.

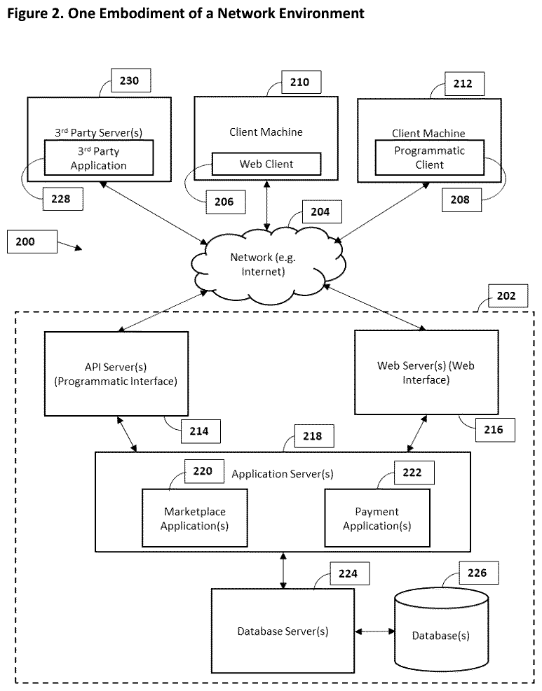

FIG. 2 is a diagram of one embodiment of a client-server system 200, within which one example embodiment may be deployed. A networked system 202, in the example form of a network-based marketplace or publication system, provides server-side functionality, via a network 204 (e.g., the Internet or Wide Area Network (WAN)) to one or more clients. FIG. 2 illustrates, for example, a web client 206 (e.g., a browser), and a programmatic client 208 executing on respective client machines 210 and 212.

An Application Program Interface (API) server 214 and a web server 216 are coupled to, and provide programmatic and web interfaces respectively to, one or more application servers 218. The application servers 218 host one or more marketplace applications 220 and payment applications 222. The application servers 218 are, in turn, shown to be coupled to one or more databases servers 224 that facilitate access to one or more databases 226.

The marketplace application(s) 220 may provide a number of marketplace functions and services to users that access the networked system 202. The payment applications 222 may provide a number of payment services and functions to users. The payment applications 222 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 220. While the marketplace and payment applications 220 and 222 are shown in FIG. 2 to each form part of the networked system 202, it will be appreciated that, in alternative embodiments, the payment applications 222 may form part of a payment service that is separate and distinct from the networked system 202.

Further, while the system 200 shown in FIG. 2 employs a client-server architecture, the present invention is of course not limited to such an architecture, and could equally well find application in a distributed, or peer-to-peer, architecture system, for example. The various marketplace and payment applications 220 and 222 could also be implemented as standalone software programs, which do not necessarily have networking capabilities.

The web client 206 accesses the various marketplace and payment applications 220 and 222 via the web interface supported by the web server 216. Similarly, the programmatic client 208 accesses the various services and functions provided by the marketplace and payment applications 220 and 222 via the programmatic interface provided by the API server 214. The programmatic client 208 may, for example, be a seller application (e.g., the TurboLister application developed by eBay Inc., of San Jose, Calif.) to enable sellers to author and manage listings on the networked system 202 in an off-line manner, and to perform batch-mode communications between the programmatic client 208 and the networked system 202.

The client machine 210 or 212 may present information to a user. For example, the client machine 210 may be running a web browser presenting a web page. The user may be a creator, and the web page may present the creator with options to enable creators to sell created digital maps, to establish the selling price of such created digital maps, to monitor the sales rate of created digital maps, and so forth. Alternatively, the user may be a customer, and the web page may present the customer with options to select digital maps to purchase, to enter one or more payment methods, and so forth. In one embodiment, a user may be able to customize their individual experience by selecting a theme, for example a famous library.

FIG. 2 also illustrates a third-party application 228, executing on a third-party server machine 230, as having programmatic access to the networked system 202 via the programmatic interface provided by the API server 214. For example, the third-party application 228 may, utilizing information retrieved from the networked system 202, support one or more features or functions on a website hosted by the third-party. The third-party website may, for example, provide one or more promotional, marketplace, social, or payment functions that are supported by the relevant applications of the networked system 202.

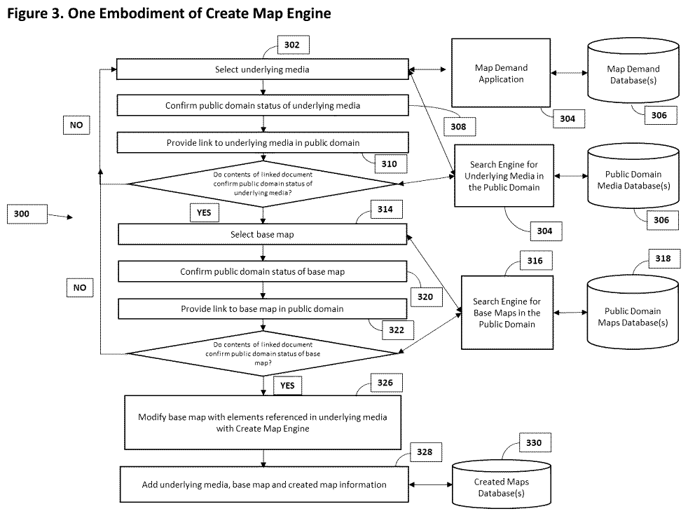

FIG. 3 is a diagram of one embodiment of a method 300 for an application server engine supporting map creation. The process may be performed by processing logic that may comprise hardware (e.g. dedicated logic, programmable logic, microcode, etc.), software (such as run on a general purpose computer system or a dedicated machine), or a combination of both. In one embodiment, processing logic resides in the application server engine 202 of FIG. 2.

Referring to FIG. 3, in one embodiment process 300 begins with processing logic determining that a creator desires to create a new digital map depicting locations, movements, or both locations and movements referenced in an underlying piece(s) of written, audio, video, virtual reality, augmented reality, mixed-reality, mixed-media, or multi-media. Locations, movements, or both locations and movements are “geographic information”. An underlying piece(s) of written, audio, video, virtual reality, augmented reality, mixed-reality, mixed-media, multi-media, or any combination thereof are “media”. In 302, said creator may select an underlying piece of media. In one embodiment, said creator may use the Map Demand Application 304 to access the Map Demand Database(s) 306, which serve to indicate how much demand there is from potential created map purchasers for a map related to a given underlying piece of media. In another embodiment, said creator may use a public domain search engine 304 to search various public domain databases 306 that contain media that are in the public domain (for example, the Project Gutenberg database lists The Adventures of Sherlock Holmes, by Arthur Conan Doyle). In an alternate embodiment, said creator may upload an underlying piece of media. In 308, said creator may confirm the public domain status of the selected or uploaded underlying piece of media, then may provide a link to the location of said selected or may upload an underlying piece of media 310. A determination may be made whether the contents of said linked or uploaded piece of media confirm the public domain status of said piece of media. In one embodiment, an automated public domain search engine 304 may search various public domain databases 306 to confirm whether said linked or uploaded underlying media is in the public domain. In an alternate embodiment, a creator may author or produce an underlying piece(s) of media.

If the public domain status of said underlying piece of media is not confirmed, the creator is returned to 302 and may select an alternate piece of underlying media. If the public domain status of said underlying piece of media is confirmed, the creator may then select a base map(s) 314 (for example the National Library of Scotland's Ordnance Survey, One-Inch England and Wales, Engraved Maps, 1872-1914, Sheet 256—North London. In one embodiment, said creator may use a public domain search engine 316 to search various public domain databases 318 that contain maps that are in the public domain. In an alternate embodiment, said creator may upload a base map. In one embodiment, said creator may confirm the public domain status of the selected or uploaded base map, then may provide a link to the location of said selected or uploaded base map 322. A determination may be made as to whether the contents of said linked or uploaded base map confirm the public domain status of said base map 320. In one embodiment, an automated public domain search engine 316 may search various public domain databases 318 to confirm whether said linked or uploaded base map is in the public domain. In an alternate embodiment, a creator map may draw or produce a base map(s).

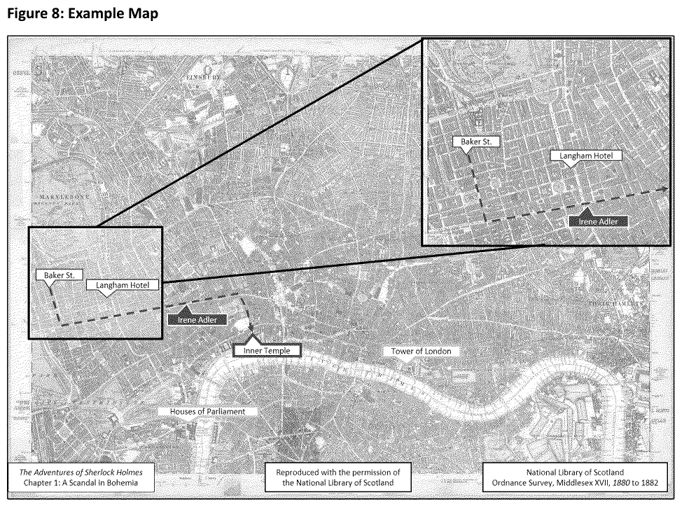

If the public domain status of said base map is not confirmed, the creator may be returned to 314 to select an alternate base map(s). If the public domain status of said base map is confirmed, the creator may next modify the base map 326 using the create map engine, for example by adding various elements to the base map that relate to locations or movements in the corresponding piece of underlying media (see FIG. 8 for an example digital map depicting locations and a character movement in The Adventures of Sherlock Holmes, Chapter 1, A Scandal in Bohemia by Sir Arthur Conan Doyle). In one embodiment, the creator may use the create map engine to easily add, remove, or modify the base map with geographic information referenced in the underlying piece of media.

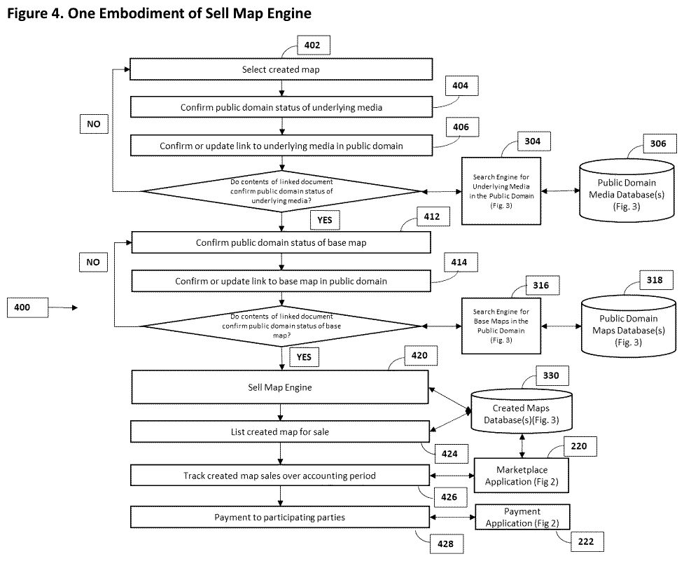

Once the creator has completed modifications to the base map, the creator may affix various informational elements (or tags) to the created map, such as the author, writer, composer, director, title, chapter, episode, track, original publication year, or other identifying elements of the underlying piece of media, the base map, or both to the created map 328. The created map may be static (such as a two-dimensional or three-dimensional graphic) or dynamic (such as a two-dimensional or three-dimensional animated graphic that plays like a video) or interactive and may be viewed in virtual reality, augmented reality, or mixed reality. Virtual reality, augmented reality, mixed reality, or any combination thereof are “XR”. After the creator has affixed tags to the created map, said created map may be stored in the created maps database(s) 330 until the creator is ready to commence the process of selling the created map (see FIG. 4).

In an alternate embodiment, the creator may select an underlying piece of media that is not in the public domain, may confirm the non-public domain status of said selected media, and may provide or upload a copy of the ownership or license agreement that permits said creator's use of such underlying media. The ownership or license agreement may be reviewed to confirm validity of the ownership or license to use the underlying media, and upon affirmative confirmation, the creator may then proceed to 314 to select a base map(s).

In another alternate embodiment, the creator may select a base map(s) that is not in the public domain, may confirm the non-public domain status of said selected base map(s), and may provide or upload a copy of the ownership or license agreement that permits said creator's use of such base map(s). The ownership or license agreement may be reviewed to confirm validity of the ownership or license to use the base map(s), and upon affirmative confirmation, the creator may then proceed to 326 to modify said base map(s).

In an alternate embodiment, the creator may select an underlying piece of media that is not in the public domain, may confirm the non-public domain status of said selected media, and may provide or upload a copy of the ownership or license agreement that permits said creator's use of such underlying media. The ownership or license agreement may be reviewed to confirm validity of the ownership or license to use the underlying media, and upon affirmative confirmation, the creator may then proceed to 314 to select a base map(s). The creator may select a base map(s) that is not in the public domain, may confirm the non-public domain status of said selected base map(s), and may provide or upload a copy of the ownership or license agreement that permits said creator's use of such base map(s). The ownership or license agreement may be reviewed to confirm validity of the ownership or license to use the base map(s), and upon affirmative confirmation, the creator may then proceed to 326 to modify said base map(s).

FIG. 4 is a diagram of one embodiment of a method 400 for an application server engine supporting map sales. The process may be performed by processing logic that may comprise hardware (e.g. dedicated logic, programmable logic, microcode, etc.), software (such as run on a general purpose computer system or a dedicated machine), or a combination of both. In one embodiment, processing logic resides in the application server engine 202 of FIG. 2.

Some time may pass between when a creator has created a new map (see FIG. 3) and when said creator is ready to sell said created new map. Referring to FIG. 4, a creator may select a map that creator has created 402 and may confirm the public domain status of the underlying media 404 and confirm or update the link to such underlying media in the public domain 406. In one embodiment, an automated public domain search engine 304 may search various public domain databases 306 to confirm whether said linked or uploaded underlying media is in the public domain. A determination may be made as to whether the contents of said linked or uploaded underlying media confirm the public domain status of said underlying media. In 412, said creator may confirm the public domain status of the selected or uploaded base map(s), then may confirm or update a link to the location of said selected or uploaded base map(s) 414. A determination may be made as to whether the contents of said linked or uploaded base map(s) confirm the public domain status of said base map(s). In one embodiment, an automated public domain search engine 316 may search various public domain databases 318 to confirm whether said linked or uploaded base map(s) is in the public domain.

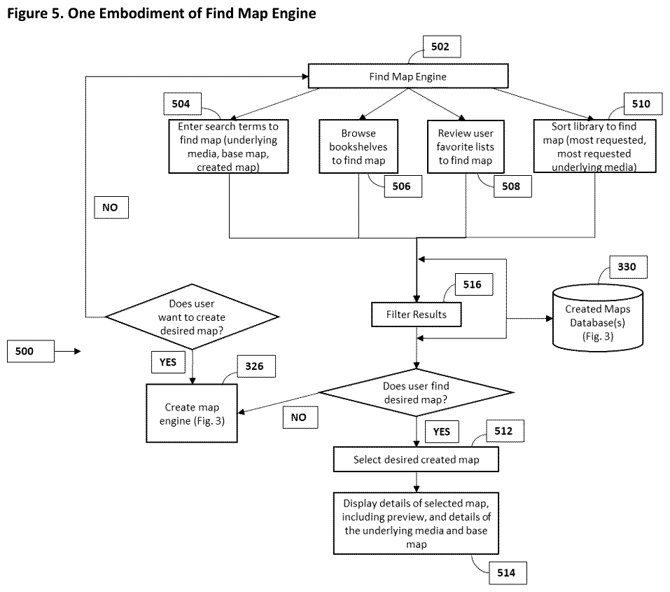

A creator may use the sell map engine 420 to establish a selling price for the creator's created map, with the engine providing highlights of one or more comparable created maps from the created maps database(s) 330 based on the tags the creator has affixed to said created map. Once a creator has established a price for the created map, said creator may list the created map for sale 424, thereby adding said created map to the created maps database 330 and making it available to find by other system users (see FIG. 5).

In one embodiment, the selling price for one or more created maps is zero (they are shared). In another embodiment, the selling price for one or more created maps is greater than zero (they are sold).

In one embodiment, the Marketplace Application 220 may process the sale of a created map to a user that purchases said created map. The Marketplace Application 220 may also record details regarding the sale such as sales date, sales price, buyer, seller and other information and may provide such sales information to the created maps database(s) 330. In one embodiment, the Marketplace Application may have a rating system, a review system, a ranking system or any combination thereof, and the buyer may provide feedback regarding the purchased created map in the form of ratings, rankings, reviews, or any combination thereof. In one embodiment, such ratings, reviews, and rankings or any combination thereof may be utilized by users in the find map engine 500, the purchase map engine 600 or both.

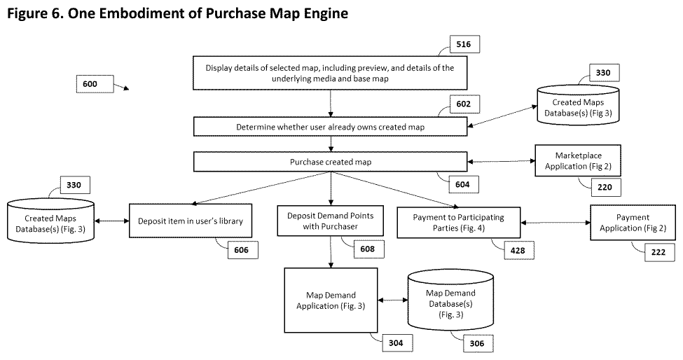

In one embodiment, the Payment Application 222 may make payment to the creator of a created map that a user has purchased (see FIG. 6) immediately upon such purchase. In an alternate embodiment, the Payment Application 222 may make payment to the creator of a created map after a given period of time (such as a day, a week, or a month), accumulating all sales by a given creator over such time period 426 and making a single payment to the creator for all sales during such time period.

In one embodiment, the Payment Application 222 may make fractional payment to parties 428 upon sale of a created map, including one or more of, but not limited to, the creator of the created map that has been sold, the provider or host of the underlying public domain media, the provider or host of the public domain base map, the licensor of the underlying media, the licensor of the base map(s), the host or provider of an application store, and the host or provider of the created maps system itself (the “participating parties”).

FIG. 5 is a diagram of one embodiment of a method 500 for an application server engine supporting map finding. The process may be performed by processing logic that may comprise hardware (e.g. dedicated logic, programmable logic, microcode, etc.), software (such as run on a general purpose computer system or a dedicated machine), or a combination of both. In one embodiment, processing logic resides in the application server engine 202 of FIG. 2.

Literature, songs, films and other forms of media often contain geographic locations and character movements among locations. Occasionally, maps accompany such media, for example a printed book that contains an overview map depicting the general geographic area where part of the story takes place. However, many pieces of original media lack maps entirely, or if maps are provided, such maps may generally be insufficient for consumers of such media to gain an adequate geographic understanding of locations and movements referenced in such media. Additionally, there is no single repository for maps related to media. Those wishing to locate maps related to media have to search a multitude of sources, each unique to the underlying piece of media.

A user may use the find map engine 502 to find created maps that reside in the created maps database(s) 330. In one embodiment, a user may use a map or digital globe to find created maps for a desired geographic location. For example, if a user is interested in created maps of London, England, said user may be able to geographically navigate to London, England in the find map engine to see available created maps featuring that location. In an alternate embodiment, the find map engine contains one or more different functions to find the desired map, including searching, browsing, reviewing, sorting or filtering. A user may enter search terms 504 related to an underlying piece of media, such as such as the author, writer, composer, director, title, chapter, episode, track, original publication year, or other identifying elements of the underlying piece of media, or author, title, original publication year, geographic location or other identifying elements of a base map, or creator, geographic location, new map creation date, or other identifying elements of a created map. A user may browse 506 virtual bookshelves or stores of underlying media or base maps or created maps to locate the desired created map. Such bookshelves or stores may organize the collections of underlying media, base maps, or created maps by author, title, original publication year, geographic location, subject, genre, or other methods of organization. Such bookshelves or stores may be visually presented in two dimensions, three dimensions, or XR. A user may review lists 508 generated and updated periodically by the find map engine 502 that display underlying media, base maps or created maps ranked by popularity (e.g. most viewed, most purchased or similar metrics), rating (e.g. highest rating) or other rank orders. A user may sort the created maps library 510 to generate a current list of underlying media, base maps or created maps by popularity, rating or other metrics. A user may filter 516 results to help refine search results. The find map engine 502 may have any or all of these features to help users find desired maps. If a user finds their desired map, the user may select said desired map 512 to view its details 514, which may include one or more of the following: a lower resolution or smaller preview picture, details of the underlying media (such as author), details of the underlying base map (such as title) or details of the created map (such as creator). In one embodiment, if the user does not find the desired map, user may opt to create such map, initiating the create map engine 326.

To give map creators some information regarding potential demand for a given map, the find map engine may track searches for underlying media, base maps, and created maps for which there is no corresponding created map in the created maps database 330. In one embodiment, map creators will be able to view ranked, sorted or filtered lists of the most requested maps. In another embodiment, users may submit a certain number of requests for maps over a given time period (for example, one request per week) and may have the option of indicating a willingness to purchase such map at a given price if it is available. In another embodiment, map creators will be able to access the map demand database 306 via the map demand application 304 to see demand from users for media that does not yet have any associated maps or for media that perhaps does not yet have a robust collection of maps available.

FIG. 6 is a diagram of one embodiment of a method 600 for an application server engine supporting map purchasing. The process may be performed by processing logic that may comprise hardware (e.g. dedicated logic, programmable logic, microcode, etc.), software (such as run on a general purpose computer system or a dedicated machine), or a combination of both. In one embodiment, processing logic resides in the application server engine 202 of FIG. 2.

A user may display the details of a selected created map 516. In one embodiment, the user may then purchase such created map. If said user desires to purchase said created map, in one embodiment the purchase map engine 600 may access the created maps database(s) 330 to determine if said user already owns such created map, and if so, display an icon or label indicating ownership of said created map 602. If not, said user may purchase said created map 604 with the marketplace application 220 completing the purchase transaction and the payment application 222 making payment to the participating parties 428. In one embodiment, once the payment application 222 has made payment to the participating parties 428, the purchased created map will be added to the purchasing user's library 606, and the created maps database(s) may be updated to reflect said user's purchase and creator's sale.

In another embodiment, after a user has purchased a created map, said user may earn “map demand” points 608. In one embodiment, the number of points may be equal to the value of the purchased created map. Said user may “spend” said map demand points within the map demand application 304 and populate the map demand database(s) 306 to signal demand for a piece of media that does not yet have any associated maps or for a piece of media lacking a robust collection of available maps. In so doing, said user is signaling to map creators that said user may be interested in purchasing a created map for the underlying piece of media, aiding map creators in understanding which underlying pieces of media would likely have the greatest demand for created maps and ultimately in selecting the underlying media 302.

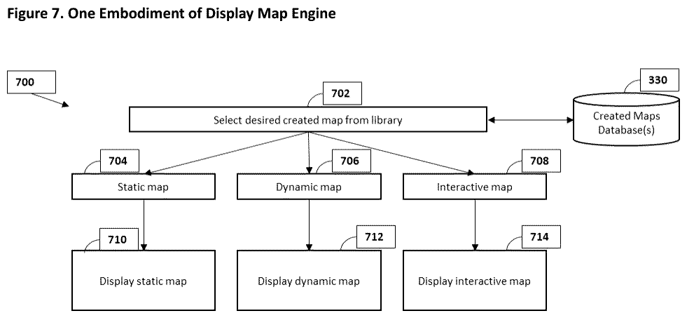

FIG. 7 is a diagram of one embodiment of a method 700 for an application server engine supporting map displaying. The process may be performed by processing logic that may comprise hardware (e.g. dedicated logic, programmable logic, microcode, etc.), software (such as run on a general purpose computer system or a dedicated machine), or a combination of both. In one embodiment, processing logic resides in the application server engine 202 of FIG. 2.

A user may select a desired created map from said user's library 702, which may be populated via access to the created maps database 330. In one embodiment, the selected map my be static 704, and may be displayed as two-dimensional (“2D”), three-dimensional (“3D”), or presented in XR 710. In another embodiment, the selected map may be dynamic 706, and may be displayed as 2D, 3D, or presented in XR 712. Said dynamic map may have control features including but not limited to playback speed, start, stop, forward, rewind and play again. In another embodiment, the selected map may be interactive 708, and may be displayed as 2D, 3D, or presented in XR 714, allowing the user to interact with the created map by tracing movements, scrolling through chapters, episodes, or volumes, or following characters or plotlines. The display method comprising one or more of static 2D, static 3D, static XR, dynamic 2D, dynamic 3D, dynamic XR, interactive 2D, interactive 3D, or interactive XR is “multi-display”. The user may be able to select certain elements to remain visible or select certain elements to hide. The user may be able to select certain character(s) or location(s), certain starting or ending points or move through time in the story of the underlying media.

FIG. 8 is an example digital map depicting locations and a character movement in Chapter 1, A Scandal in Bohemia of The Adventures of Sherlock Holmes by Sir Arthur Conan Doyle. The Adventures of Sherlock Holmes is in the public domain in the United States and serves as the underlying piece of media. The National Library of Scotland's Ordnance Survey, One-Inch England and Wales, Engraved Maps, 1872-1914, Sheet 256—North London, is in the creative commons and serves as the base map.

What is claimed is:

1. An apparatus for handling digital map(s) depicting geographic information referenced in media, the handling comprising one or more of the following:
creating a digital map depicting geographic information referenced in media, the creating comprising one or more of the following:
selecting an underlying piece(s) of media, including possibly using a map demand application to understand which potential created digital maps would have the most demand from prospective purchasers;
checking the public domain status or license status of an underlying piece(s) of media;
selecting a base map(s) for said selected piece(s) of media;
checking the public domain status or license status of a base map(s);
adding elements referenced in an underlying piece(s) of media to said base map(s) that depict geographic information referenced in said underlying piece(s) of media;
affixing various informational elements or tags to the created map, including the author, writer, composer, director, title, chapter, episode, track, original publication year, or other identifying elements of the underlying piece(s) of media, the base map(s), or both to the created map(s);
selling a digital map(s) depicting geographic information referenced in media, the selling comprising one or more of the following:
selecting a created map(s);
confirming the public domain status or license status of an underlying piece(s) of media;
confirming the public domain status or license status of a base map(s);
setting a price for the created digital map(s), possibly based on information provided by the sell map engine;
affixing various informational elements or tags to the created map, including the author, writer, composer, director, title, chapter, episode, track, original publication year, or other identifying elements of the underlying piece(s) of media, the base map(s), or both to the created map(s);
making a fractional payment to parties upon sale of a created map, including one or more of, but not limited to, the creator of the created map that has been sold, the provider or host of the piece(s) of underlying public domain media, the provider or host of the public domain base map(s), the licensor of the piece(s) of underlying media, the licensor of the base map(s), the host or provider of an application store, and the host or provider of the created maps system itself;
finding a digital map(s) depicting geographic information referenced in media, the finding comprising one or more of the following:
navigating to a geographic location using the find map engine to find a created map(s) featuring said geographic location;
searching a digital library of available maps by entering search terms related to an underlying piece(s) of media, including one or more of the following: author, writer, composer, director, title, chapter, episode, track, original publication year, or other identifying elements of the underlying piece(s) of media;
searching a digital library of available maps by entering search terms related to a base map(s), including one or more of the following: author, title, original publication year, geographic location or other identifying elements of a base map(s);
searching a digital library of available maps by entering search terms related to a created map, including one or more of the following: creator, geographic location, map creation date, or other identifying elements of a created map(s);
browsing a digital library or digital bookshelves organized by the collections of underlying piece(s) of media, base map(s), or created map(s) by author, title, original publication year, geographic location, subject, genre, or other methods of organization, as may be presented visually in two dimensions, three dimensions, or XR;
reviewing lists generated and updated periodically by the find map engine that display underlying media, base map(s) or created map(s) ranked by popularity, rating or other rank orders;
sorting or filtering the results of searching, browsing or reviewing to refine results;
purchasing a digital map(s) depicting geographic information referenced in media, the purchasing comprising one or more of the following:
selecting the desired digital map(s) from among the results displayed via navigating to a geographic location or searching the digital library or entering search terms;
purchasing the selected digital map(s), initiating fractional payments to parties including one or more of, but not limited to, the creator of the created map(s) that has been sold, the provider or host of the underlying piece(s) of public domain media, the provider or host of the public domain base map(s), the licensor of the underlying piece(s) of media, the licensor of the base map(s), the host or provider of an application store, and the host or provider of the created maps system itself;
earning map demand points correlated to the purchase of a created map(s), such points to be spent, or banked and subsequently spent, by the purchaser of said created map(s) within the map demand application to signal demand for a piece(s) of media that does not yet have any associated maps or for a piece(s) of media with an insufficient set of available maps;
displaying a digital map(s) depicting geographic information referenced in media, the displaying comprising one or more of the following:
selecting a desired digital map(s) from among various digital map(s) in a user's digital library;
displaying a selected digital map(s) using the display map engine, with said digital map(s) being displayed in multi-display;
manipulating a displayed map by tracing character movements, scrolling through chapters, episodes, or volumes, selecting certain elements to remain visible, selecting certain elements to hide, selecting certain chapters or episodes, selecting certain locations, selecting certain starting or ending points, or progressing through the plot or theme of the underlying piece(s) of media.

2. The apparatus of claim 1, wherein a user utilizes the create map engine to create a new digital map(s) that depicts geographic information referenced in an underlying piece(s) of media.

3. The apparatus of claim 1, wherein a user utilizes the sell map engine to help sell the user's created digital map(s) that depicts geographic information referenced in an underlying piece(s) of media.

4. The apparatus of claim 1, wherein a user utilizes the find map engine to find a digital map(s) that depicts geographic information referenced in an underlying piece(s) of media.

5. The apparatus of claim 1, wherein a user utilizes the purchase map engine to purchase a digital map(s) that depicts geographic information referenced in an underlying piece(s) of media.

6. The apparatus of claim 1, wherein a user utilizes the display map engine to display a purchased digital map(s) that depicts geographic information referenced in an underlying piece(s) of media.

7. A system for handling digital map(s) depicting geographic information referenced in media, the handling comprising one or more of the following:
creating a digital map depicting geographic information referenced in media, the creating comprising one or more of the following:
selecting an underlying piece(s) of media, including possibly using a map demand application to understand which potential created digital maps would have the most demand from prospective purchasers;
checking the public domain status or license status of an underlying piece(s) of media;
selecting a base map(s) for said selected piece(s) of media;
checking the public domain status or license status of a base map(s);
adding elements referenced in an underlying piece(s) of media to said base map(s) that depict geographic information referenced in said underlying piece(s) of media;
affixing various informational elements or tags to the created map, including the author, writer, composer, director, title, chapter, episode, track, original publication year, or other identifying elements of the underlying piece(s) of media, the base map(s), or both to the created map(s);
selling a digital map(s) depicting geographic information referenced in media, the selling comprising one or more of the following:
selecting a created map(s);
confirming the public domain status or license status of an underlying piece(s) of media;
confirming the public domain status or license status of a base map(s);
setting a price for the created digital map(s), possibly based on information provided by the sell map engine;
affixing various informational elements or tags to the created map, including the author, writer, composer, director, title, chapter, episode, track, original publication year, or other identifying elements of the underlying piece(s) of media, the base map(s), or both to the created map(s);
making a fractional payment to parties upon sale of a created map, including one or more of, but not limited to, the creator of the created map that has been sold, the provider or host of the piece(s) of underlying public domain media, the provider or host of the public domain base map(s), the licensor of the piece(s) of underlying media, the licensor of the base map(s), the host or provider of an application store, and the host or provider of the created maps system itself;
finding a digital map(s) depicting geographic information referenced in media, the finding comprising one or more of the following:
navigating to a geographic location using the find map engine to find a created map(s) featuring said geographic location;
searching a digital library of available maps by entering search terms related to an underlying piece(s) of media, including one or more of the following: author, writer, composer, director, title, chapter, episode, track, original publication year, or other identifying elements of the underlying piece(s) of media;
searching a digital library of available maps by entering search terms related to a base map(s), including one or more of the following: author, title, original publication year, geographic location or other identifying elements of a base map(s);
searching a digital library of available maps by entering search terms related to a created map, including one or more of the following: creator, geographic location, map creation date, or other identifying elements of a created map(s);
browsing a digital library or digital bookshelves organized by the collections of underlying piece(s) of media, base map(s), or created map(s) by author, title, original publication year, geographic location, subject, genre, or other methods of organization, as may be presented visually in two dimensions, three dimensions, or XR;
reviewing lists generated and updated periodically by the find map engine that display underlying media, base map(s) or created map(s) ranked by popularity, rating or other rank orders;
sorting or filtering the results of searching, browsing or reviewing to refine results;
purchasing a digital map(s) depicting geographic information referenced in media, the purchasing comprising one or more of the following:
selecting the desired digital map(s) from among the results displayed via navigating to a geographic location or searching the digital library or entering search terms;
purchasing the selected digital map(s), initiating fractional payments to parties including one or more of, but not limited to, the creator of the created map(s) that has been sold, the provider or host of the underlying piece(s) of public domain media, the provider or host of the public domain base map(s), the licensor of the underlying piece(s) of media, the licensor of the base map(s), the host or provider of an application store, and the host or provider of the created maps system itself;
earning map demand points correlated to the purchase of a created map(s), such points to be spent, or banked and subsequently spent, by the purchaser of said created map(s) within the map demand application to signal demand for a piece(s) of media that does not yet have any associated maps or for a piece(s) of media with an insufficient set of available maps;
displaying a digital map(s) depicting geographic information referenced in media, the displaying comprising one or more of the following:
selecting a desired digital map(s) from among various digital map(s) in a user's digital library;
displaying a selected digital map(s) using the display map engine, with said digital map(s) being displayed in multi-display;
manipulating a displayed map by tracing character movements, scrolling through chapters, episodes, or volumes, selecting certain elements to remain visible, selecting certain elements to hide, selecting certain chapters or episodes, selecting certain locations, selecting certain starting or ending points, or progressing through the plot or theme of the underlying piece(s) of media.

8. The system of claim 7, wherein a user utilizes the create map engine to create a new digital map(s) that depict geographic information referenced in an underlying piece(s) of media.

9. The system of claim 7, wherein a user utilizes the sell map engine to help sell the user's created digital map(s) that depict geographic information referenced in an underlying piece(s) of media.

10. The system of claim 7, wherein a user utilizes the find map engine to find a digital map(s) that depicts geographic information referenced in an underlying piece(s) of media.

11. The system of claim 7, wherein a user utilizes the purchase map engine to purchase a digital map(s) that depicts geographic information referenced in an underlying piece(s) of media.

12. The system of claim 7, wherein a user utilizes the display map engine to display a purchased digital map(s) that depicts geographic information referenced in an underlying piece(s) of media.

13. A non-transitory computer-readable storage medium storing computer-executable instructions for execution by a processor to perform a method, the method comprising handling digital map(s) depicting geographic information referenced in media, the handling comprising one or more of the following:
creating a digital map depicting geographic information referenced in media, the creating comprising one or more of the following:
selecting an underlying piece(s) of media, including possibly using a map demand application to understand which potential created digital maps would have the most demand from prospective purchasers;
checking the public domain status or license status of an underlying piece(s) of media;
selecting a base map(s) for said selected piece(s) of media;
checking the public domain status or license status of a base map(s);
adding elements referenced in an underlying piece(s) of media to said base map(s) that depict geographic information referenced in said underlying piece(s) of media;
affixing various informational elements or tags to the created map, including the author, writer, composer, director, title, chapter, episode, track, original publication year, or other identifying elements of the underlying piece(s) of media, the base map(s), or both to the created map(s);
selling a digital map(s) depicting geographic information referenced in media, the selling comprising one or more of the following:
selecting a created map(s);
confirming the public domain status or license status of an underlying piece(s) of media;
confirming the public domain status or license status of a base map(s);
setting a price for the created digital map(s), possibly based on information provided by the sell map engine;
affixing various informational elements or tags to the created map, including the author, writer, composer, director, title, chapter, episode, track, original publication year, or other identifying elements of the underlying piece(s) of media, the base map(s), or both to the created map(s);
making a fractional payment to parties upon sale of a created map, including one or more of, but not limited to, the creator of the created map that has been sold, the provider or host of the piece(s) of underlying public domain media, the provider or host of the public domain base map(s), the licensor of the piece(s) of underlying media, the licensor of the base map(s), the host or provider of an application store, and the host or provider of the created maps system itself;
finding a digital map(s) depicting geographic information referenced in media, the finding comprising one or more of the following:
navigating to a geographic location using the find map engine to find a created map(s) featuring said geographic location;
searching a digital library of available maps by entering search terms related to an underlying piece(s) of media, including one or more of the following: author, writer, composer, director, title, chapter, episode, track, original publication year, or other identifying elements of the underlying piece(s) of media;
searching a digital library of available maps by entering search terms related to a base map(s), including one or more of the following: author, title, original publication year, geographic location or other identifying elements of a base map(s);
searching a digital library of available maps by entering search terms related to a created map, including one or more of the following: creator, geographic location, map creation date, or other identifying elements of a created map(s);
browsing a digital library or digital bookshelves organized by the collections of underlying piece(s) of media, base map(s), or created map(s) by author, title, original publication year, geographic location, subject, genre, or other methods of organization, as may be presented visually in two dimensions, three dimensions, or XR;
reviewing lists generated and updated periodically by the find map engine that display underlying media, base map(s) or created map(s) ranked by popularity, rating or other rank orders;
sorting or filtering the results of searching, browsing or reviewing to refine results;
purchasing a digital map(s) depicting geographic information referenced in media, the purchasing comprising one or more of the following:
selecting the desired digital map(s) from among the results displayed via navigating to a geographic location or searching the digital library or entering search terms;
purchasing the selected digital map(s), initiating fractional payments to parties including one or more of, but not limited to, the creator of the created map(s) that has been sold, the provider or host of the underlying piece(s) of public domain media, the provider or host of the public domain base map(s), the licensor of the underlying piece(s) of media, the licensor of the base map(s), the host or provider of an application store, and the host or provider of the created maps system itself;
earning map demand points correlated to the purchase of a created map(s), such points to be spent, or banked and subsequently spent, by the purchaser of said created map(s) within the map demand application to signal demand for a piece(s) of media that does not yet have any associated maps or for a piece(s) of media with an insufficient set of available maps;
displaying a digital map(s) depicting geographic information referenced in media, the displaying comprising one or more of the following:
selecting a desired digital map(s) from among various digital map(s) in a user's digital library;
displaying a selected digital map(s) using the display map engine, with said digital map(s) being displayed in multi-display;
manipulating a displayed map by tracing character movements, scrolling through chapters, episodes, or volumes, selecting certain elements to remain visible, selecting certain elements to hide, selecting certain chapters or episodes, selecting certain locations, selecting certain starting or ending points, or progressing through the plot or theme of the underlying piece(s) of media.

14. The non-transitory computer-readable storage medium storing computer-executable instructions for execution by a processor to perform a method of claim 13, wherein the method comprises a user utilizing the create map engine to create a new digital map(s) that depict geographic information referenced in an underlying piece(s) of media.

15. The non-transitory computer-readable storage medium storing computer-executable instructions for execution by a processor to perform a method of claim 13, wherein the method comprises a user utilizing the sell map engine to help sell the user's created digital map(s) that depict geographic information referenced in an underlying piece(s) of media.

16. The non-transitory computer-readable storage medium storing computer-executable instructions for execution by a processor to perform a method of claim 13, wherein the method comprises a user utilizing the find map engine to find a digital map(s) that depicts geographic information referenced in an underlying piece(s) of media.

17. The non-transitory computer-readable storage medium storing computer-executable instructions for execution by a processor to perform a method of claim 13, wherein the method comprises a user utilizing the purchase map engine to purchase a digital map(s) that depicts geographic information referenced in an underlying piece(s) of media.

18. The non-transitory computer-readable storage medium storing computer-executable instructions for execution by a processor to perform a method of claim 13, wherein the method comprises a user utilizing the display map engine to display a purchased digital map(s) that depicts geographic information referenced in an underlying piece(s) of media.
